(19) United States
(12) Patent Application Publication
(10) Pub. No.: US 2002/0010616 A1
(43) Pub. Date: Jan. 24, 2002

(54) System and method for dissemination of counseling and advice in a distributed networking environment

(76) Inventor: Dani Itzhaki, Hollywood, FL (US)

Correspondence Address: Anthony R. Barkume, Greenberg Traurig, LLP, 200 Park Avenue, New York, NY, 10166, US

(21) Appl. No.: 09/836,873

(22) Filed: Apr. 17, 2001

Related U.S. Application Data
(60) Provisional application No. 60/197,961, filed on Apr. 17, 2000.

(51) Int. Cl. G06F 17/60

(52) U.S. Cl. 705/9

(57) ABSTRACT

A method of connecting a client to a counselor over a communications network comprises a counselor logging into a counseling service and indicating availability for connection to a client. A client logs into the counseling service and is presented with a list of counselors and the times slots in which they are available. The client selects a counselor from the list of counselors and time slots and schedules a time slot for a session with the counselor. At the scheduled time, the counselor is contacted by the service for connection to the client, and the service establishes a communication connection between the client and the selected counselor.

### CROSS REFERENCE TO RELATED U.S. APPLICATIONS

This application claims priority from Itzhaki, “SYSTEM AND METHOD FOR DISSEMINATION OF COUNSELING AND ADVICE IN A DISTRIBUTED NETWORKING ENVIRONMENT”, U.S. Provisional patent application Ser. No. 60/197,961, filed Apr. 17, 2000, the contents of which are incorporated herein by reference.

### BACKGROUND OF THE INVENTION

This invention relates to the use of a distributed networking environment such as the Internet for providing health and other types of advice and counseling services to a group of consumers.

Health information is one of the top reasons consumers search the Internet. Industry consultants estimate that by mid-2000 over 33 million adults in the United States will be searching for healthcare and mental health will play a vital role. It is estimated that the potential size of the Internet e-health market will be approximately $205 billion in 2003, with an expected growth rate in excess of at least 300% annually over the next five years. The forecast assumes that e-commerce opportunities for e-business and consumers will account for $168 billion and $28 billion respectively, with on-line advertising spending roughly $400 million.

With the Internet, mental healthcare clients worldwide can access the Company's information and services. Both business-to-consumer and business-to-business e-commerce has significant revenue value.

Today, an estimated 20,000 web sites provide health information to the community. Health content is growing at 300,000 pages per day. Ready or not, the Internet is profoundly transforming healthcare. Over 1.5 million consumers actually chose their physician through on-line referrals.

E-commerce will shortly emerge as a key revenue source for e-mental health consumer portals. Many sites now offer a range of free services as a way to achieve site “stickness” and to drive consumers to their web pages. Many e-mental health enterprises are partnering with pharmacies, insurance companies, product catalogs, etc.

In addition to trying to generate revenues through e-commerce initiatives, well-financed e-mental healthcare portals are forging relationships with major media outlets. These relationships are intended to drive “eyeballs” to their sites, enhance e-commerce activities, increase brand recognition and create customer loyalty. Although these relationships provide significant value, they are costly and require public money.

### SUMMARY OF THE INVENTION

The present invention is in one preferred embodiment a counseling service comprising a nationwide network of licensed psychologists and counselors. These psychologists are cross-trained and specialize in psychological gender-specific issues such as stress, sexual issues, divorce, loss of a loved ones, child raising, and financial problems. The service can be offered on a pay-per-call or a pre-paid basis providing confidential, valuable, relevant and helpful information on general mental health topics to consumers at a time most convenient to them.

The present invention provides its services and products using Internet-based call center technologies such as inbound 800 services, integrated WEB/Callback, and Voice and Video over Internet Protocol. For the first time the client will have the ability to instantaneously interact with a psychologist on a pay-per-call basis, 24 hours per day, 7 days a week, 365 days a year. The method of payment can either be by credit card, check by phone, the use of a 900-telephone number, or by purchasing prepaid minutes at a discount.

The service supports several communications modes by which counselors can be connected to clients. These modes, referred to herein as channels, include a telephone connection, an Internet chat room, a voice-over-Internet connection, and a video-over-Internet connection. Psychologists, doctors, social workers and other counselors, collectively referred to herein as counselors, who are part of the service's network provide the service with a schedule of when they are available, and over which communications mode. To make oneself available, a counselor logs into the service's network. This is preferably done by logging in the service's web site and marking oneself as available. Alternatively, a counselor can log in and make oneself available via an interactive voice response system during a phone call. Once the counselor is marked as available, he or she then waits to be contacted by the system for connection to a client.

A client can connect to the service either by means of a phone call or over a computer network, such as the Internet. Once a client is logged in and a mode of payment has been selected, the client is presented with a schedule of available counselors. This schedule includes the channel for each counselor, and each counselor's areas of specialization. The client selects a counselor and time of contact from this list, and at the selected time the service contacts the client and the counselor in order to establish the communication link between them. This communication link is completely confidential. This ability for the system to connect a client to a counselor at a specified time is referred to as the callback feature of the invention.

The technology used by the present invention is a proprietary telephony infrastructure integrated with a web centric customer call center. The system architecture will provide a secure and confidential link between the client and the psychologist.

The system's clients will have the ability to choose from a nationwide network of over several thousand psychologists. The services rendered are from the psychologist's home or office.

Additionally, the system will provide a host of other services such as chat rooms and bulletin boards for clients, instant messaging, and for clients with email accounts, the system can send them the latest updates mental health news.

### BRIEF DESCRIPTION OF THE DRAWINGS

FIG. 1 illustrates the architecture of the system of the invention.

FIG. 2 is a flowchart of how a counselor becomes registered with the service of the invention.

FIG. 3 is a flowchart of how a counselor indicates availability to clients.

FIG. 4 is a flowchart of how the system of the invention connects counselors to clients.

FIG. 5 is an exemplary availability management table for a counselor to mange his or her availability.

FIG. 6 is a flowchart of how a counselor can create and manage his or her schedule.

FIG. 7 depicts an exemplary schedule for a counselor.

FIG. 8 is a flowchart of how a client registers with the service of the invention.

FIG. 9 is an exemplary web page for a client to find a suitable counselor.

FIG. 10 is an exemplary web page displaying a list of available counselors according to the criteria selected by the client.

FIG. 11 is an exemplary web page displaying the availability schedule of a counselor on the list of FIG. 10.

FIG. 12 is a flowchart of how a client is prompted for payment by the system of the invention.

### DETAILED DESCRIPTION OF THE INVENTION

The counseling service (“service”) of the invention includes a nationwide network of counselors. The service maintains a web site that provides clients, counselors, system administrators, and customer service representatives access to the system. The system web site can also be interfaced with the telephone network for calling and connecting clients with counselors and customer service representatives and a charge card authorization system to enable clients to use their credit cards as payment for services.

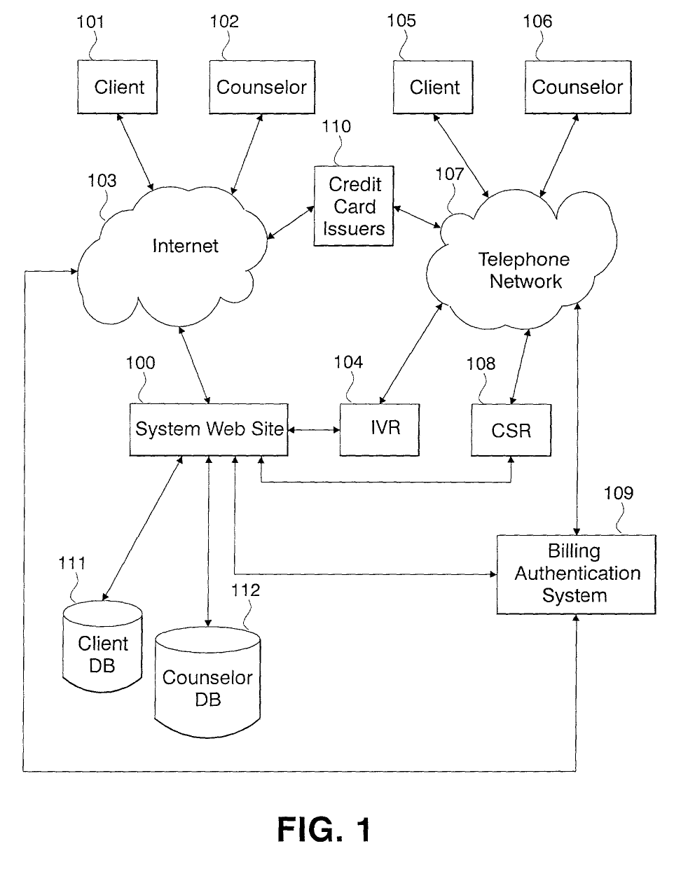

The architecture of the network of the invention is depicted in FIG. 1. In one preferred embodiment, the system includes a web site 100 to which a client 101 and a counselor 102 can be connected via the Internet 103. The system includes an interactive voice response (“IVR”) subsystem 104 so that a client 105 can be connected to a counselor 106 over the telephone network 107. For those clients who prefer to interact with human beings as opposed to machines, the system includes customer service representatives 108 (“CSRs”) who can perform the same task. The system also includes a billing authentication system 109 that can contact credit card issuers 110 via either the Internet 103 or the telephone network 107. In addition, the system maintains a client database 111 to store information about the system's clients, and a counselor database 112 to store information about the system counselor's.

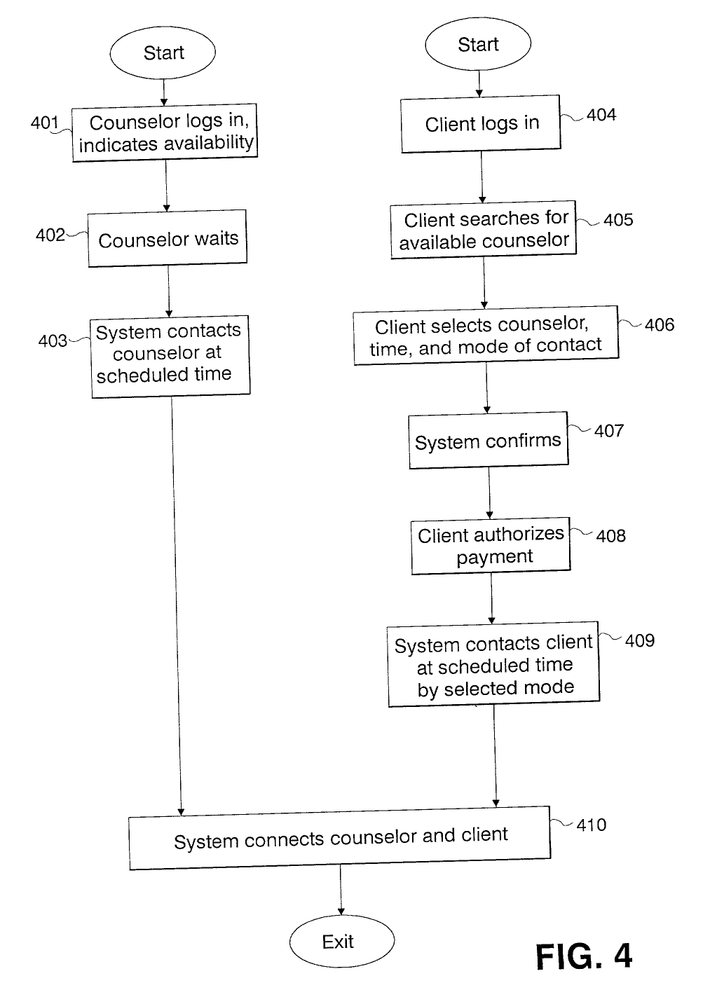

An overview of the process by which a counselor logs into the service, indicates availability, and waits to be connected to a client, and by which a client logs into the service, searches for a suitable counselor, schedules an appointment, and is connected to the counselor, is depicted in FIG. 4. First, a counselor logs into the system, indicates availability at step 401, and waits to be contacted at step 402. A client seeking counseling logs in at step 404, and searches for an available counselor at step 405. Once a client has selected a counselor, session time (which can be immediately) and mode of contact at step 406, the system confirms that the counselor is available at step 407, and authorizes payment at step 408. When the time for the appointment arrives, the system contacts the client at step 409 by the selected mode of contact. The system then contacts the counselor at step 403, and connects the counselor to the client at step 410.

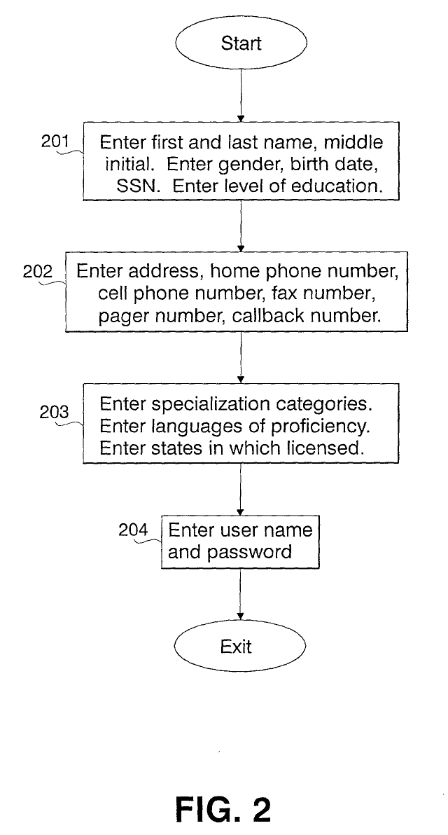

Counselors can become members of the service by registering at the service's web site. The web site presents a plurality of pages to a prospective member requesting information about the counselor. This information includes the counselor's name, age, gender, social security number, address and phone numbers. At least one phone number serves as a callback number for the counselor for telephone connections to clients. In addition, prospective counselor members are requested to enter their level of education, areas of specialty, what languages they speak, the states in which they are licensed, and to select a user name and password. A flowchart of this process is depicted in FIG. 2. Among the specialties supported by the service are aging, gay and lesbian issues, grief and loss, health, parenting, relationships, sexuality, spirituality, stress, teenagers, and workplace issues. The service can also provide counseling in most of the national languages spoken in the world. The counselor's user name serves as a callback number for Internet and web based counseling sessions, in accordance with techniques well known in the art. The method by which counselor's are compensated for their services is contractually agreed upon as part of the registration process, and is typically an hourly rate based on the number of hours a counselor actually provides counseling.

The information entered by the counselor forms a counselor profile that is stored in the counselor database by the system. This profile can be subsequently modified by the counselor.

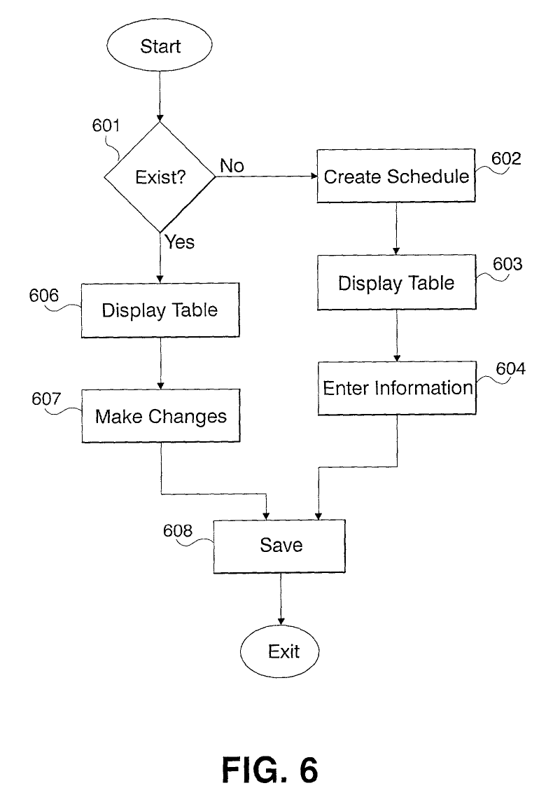

The service provides its affiliated counselors the ability to create, view, and modify their schedule at the service's website, a process depicted in FIG. 6. If a schedule does not exist, a counselor will create a schedule at step 602, and the system displays at step 603 a form that includes fields for each day of the week, along with start time, end time and schedule status. In a preferred embodiment, the system supports three categories of schedule status: (1) “Scheduled”, which means the counselor will probably be available at that time; (2) “Reserve Duty”, which means that there is a possibility that the counselor will be available at that time: and (3) “Off duty”, the default status, which means the counselor is not available. The counselor enters schedule information at step 604. The system ensures that there are no conflicts with the counselor's schedule, that is, that the counselor has selected only one schedule status for each time period. As part of entering schedule information, the counselor also indicates the channel (or channels) over which he or she is available.

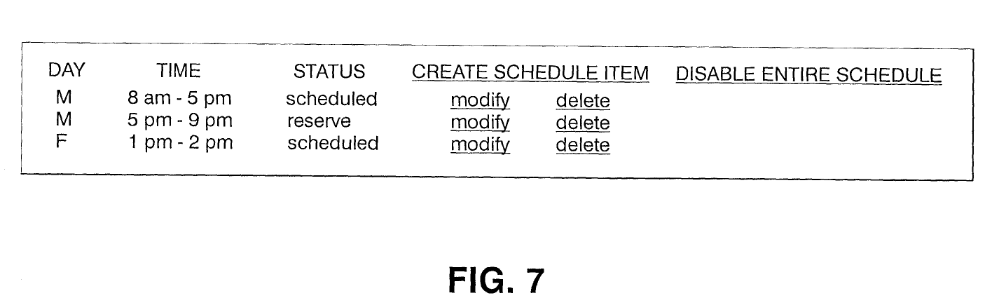

If the counselor is modifying an existing schedule, the system displays at step 606 a listing of the counselor's schedule. This indicates the counselors status for those days and times for which he or she is not off duty. There are also links that enable the counselor to modify or delete a scheduled time slot, and links that enable the counselor to create a new schedule item and to disable the entire schedule. An example of such a table is depicted in FIG. 7. The counselor makes the desired changes at step 607, and saves the changes at step 608.

It is only when the counselor logs into the system and indicates his or her availability, either by logging onto the service's web site, or by calling the service's 800 number and either using the IVR or speaking to a CSR, however, that the schedule is confirmed. Once the counselor is marked as available, he or she waits until contacted by the system for connection to a client.

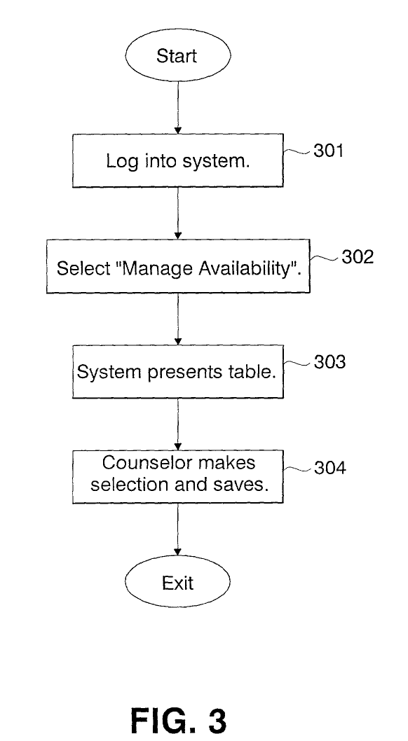

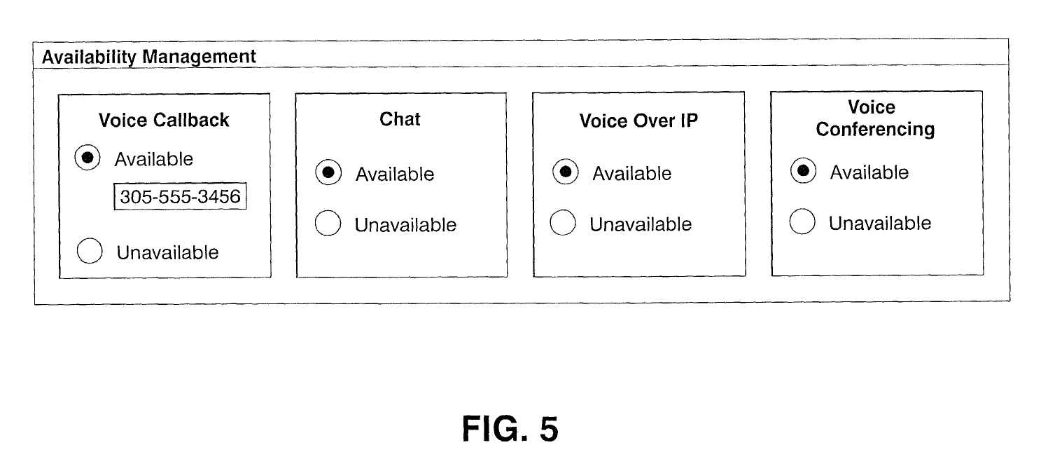

Even after a counselor has logged into the system and marked him or herself as available, the service provides affiliated counselors the ability to manage their availability, a process depicted in FIG. 3. This can be done either by telephone or over the web. Via the web, the counselor first logs in to the system at step 301 and authenticates him or herself by entering a password. The counselor then selects a manage availability option at step 302, after which the system presents at step 303 a table displaying the counselor's availability for all available channels. An example of such a table is depicted in FIG. 5. The counselor can then modify his or her availability status for each channel. In addition, for the telephone channel, the counselor can modify the callback phone number used by the system for connection to a client.

The counselor can also call the service's 800 number to manage availability, if, for example, the counselor does not have web access. The IVR system prompts the counselor to enter a user name and password, and then prompts the counselor to mark him or herself as available or unavailable for each channel. The IVR system can transmit the counselor's responses to the system managing the service. The IVR system utilized in the present invention is of course well known in the art.

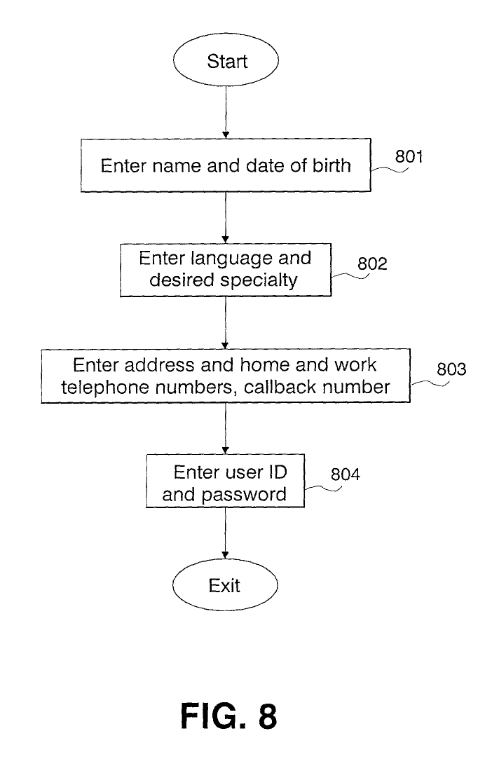

A client can access the system either by telephone or via the system's web site. A first time user is prompted to register with the system. If the client is accessing the system via the web site, he or she is presented with a sequence of pages prompting the user to enter information such as name, gender, date of birth, interests, mailing address, phone number, email address, and to select a user ID and a password. A flowchart of the client registration process is depicted in FIG. 8. This information is used to create a profile for the client. If a user is accessing the system via a phone call, an IVR system prompts the user to enter the required information. Clients who are uncomfortable with the automated setting of an IVR can opt to speak to a CSR. Once entered, the profile can be modified by the client at any time.

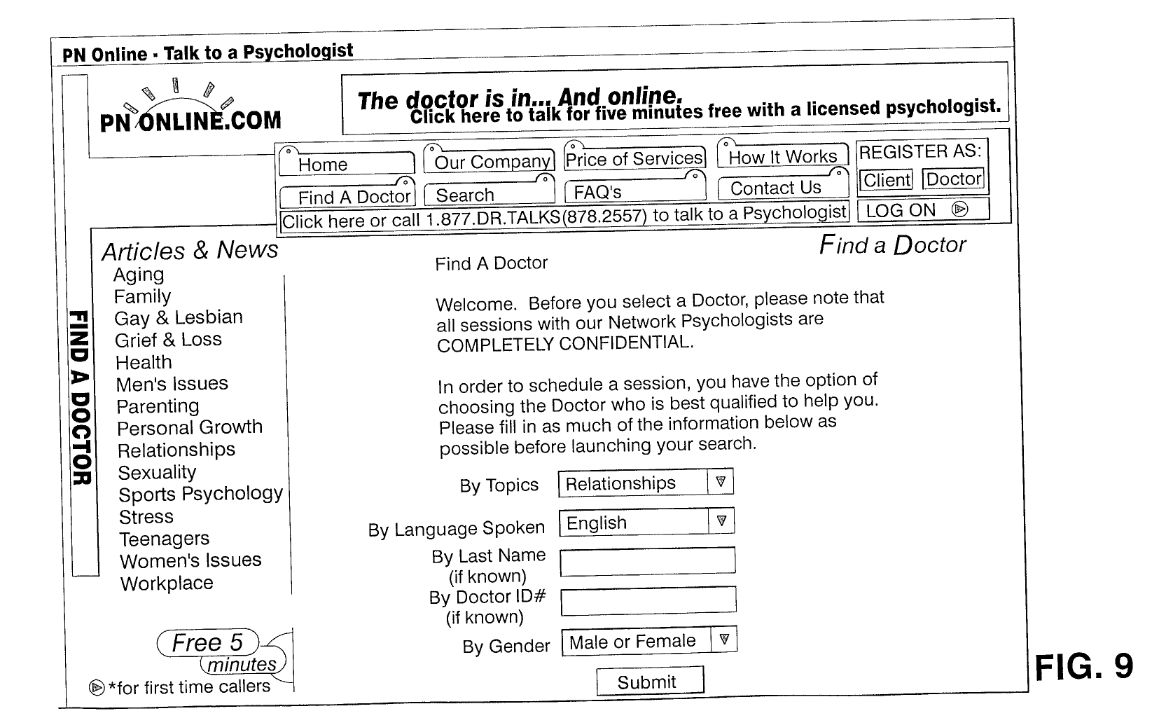

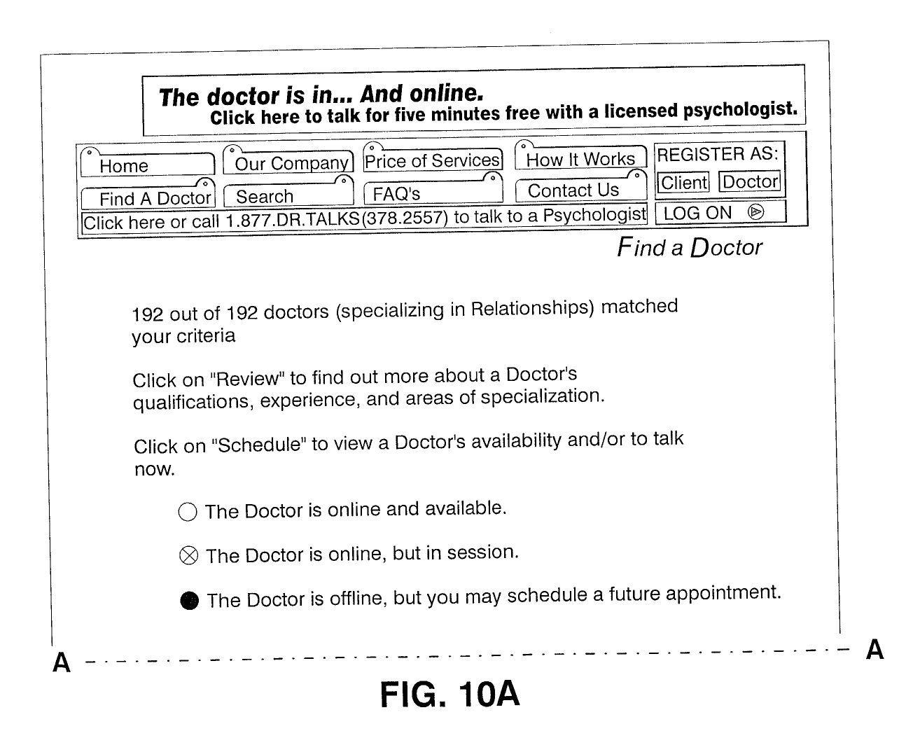

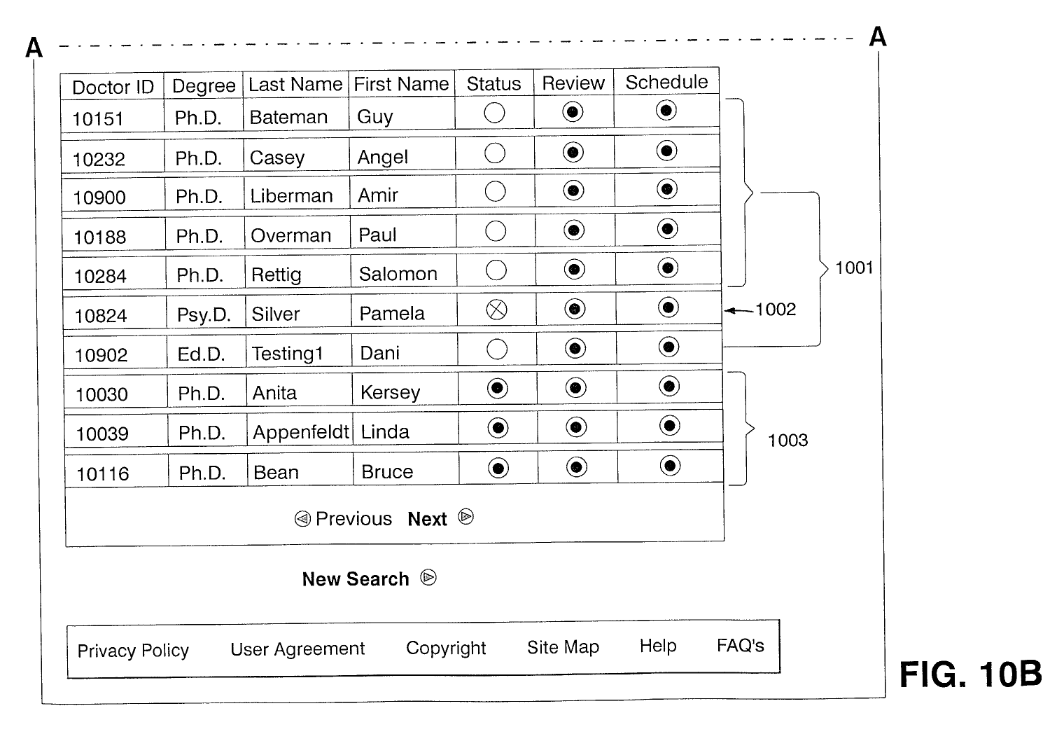

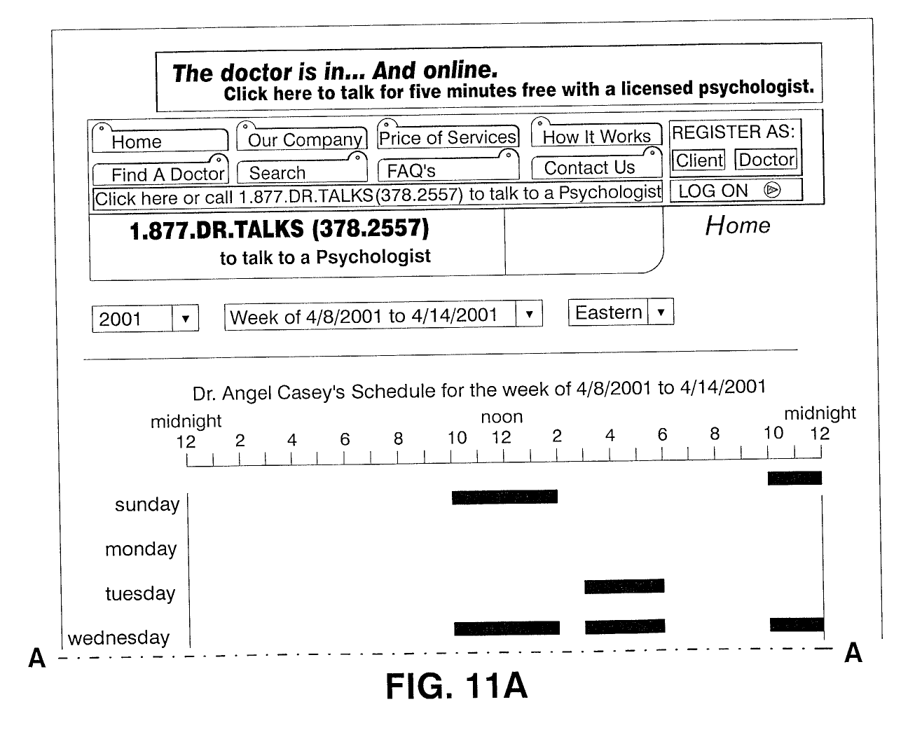

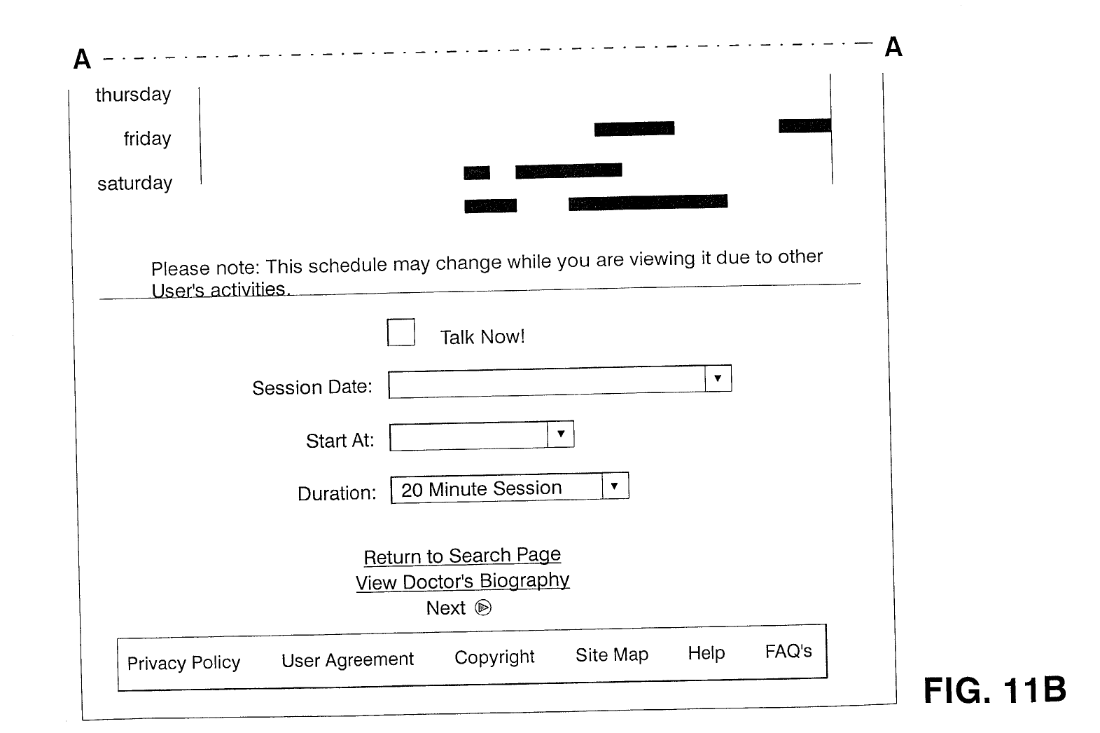

A user who is a registered client of the system can access the system by either the web site or a telephone call in order to be connected to a counselor. Via the web site, the client selects “Find a Doctor”, after which the system displays a page displaying various counselor categories. An example of a web page used for finding a counselor is depicted in FIG. 9. These categories include area of specialization, language spoken, and the counselor's gender. This enables the system to find a list of counselors best matched to the client's needs. After the client submits the page, the system returns another web page, an example of which is depicted in FIG. 10, to the client that displays a list of available counselors for the categories selected by the user. This page depicts the counselor's name, degree, ID number, status, and includes links for the client to view the counselor's profile and schedule, and to schedule an appointment. The status buttons indicate whether the counselor is online and available (white buttons), online but in session (cross hatched button), or offline (black buttons). As shown in the figure, the counselors 1001 are online and available, counselor 1002 is online and in session, and counselors 1003 are offline. Selecting the “Schedule” button displays that counselor's schedule page to the client. An exemplary schedule page is depicted in FIG. 11. The schedule page can also include those channels over which the counselor is available. To schedule an appointment, the client selects either the “Talk Now” link for an immediate appointment, or else enters the date, time, and desired duration for a future appointment. The client will also be prompted to enter personal information, such as name, callback number, user name, and password to confirm the appointment.

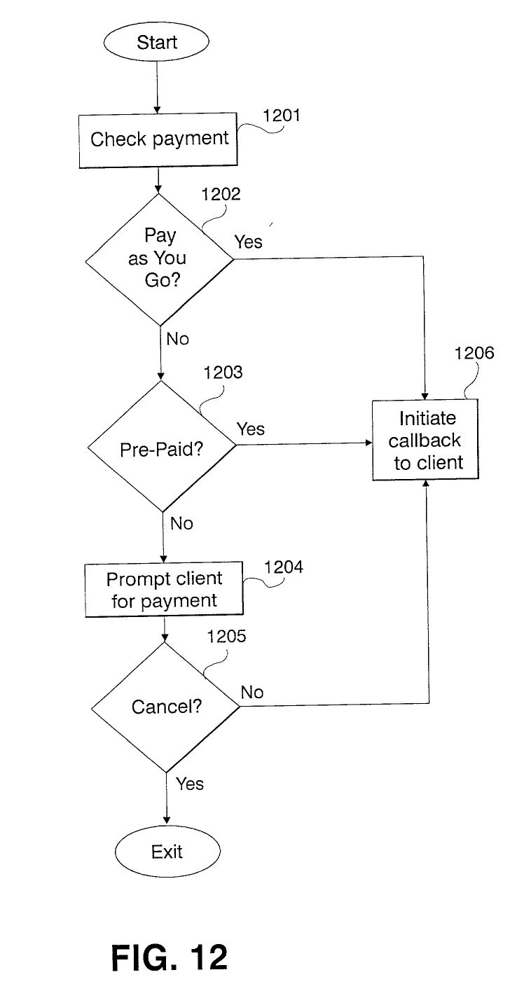

Once the client has scheduled an appointment, the system checks for payment authorization, a process depicted in FIG. 12. If a client has authorized pay-as-you-go by a credit card at step 1202, or has a sufficient balance in a pre-paid account at step 1203, the system will initiate the callback to the client at the scheduled time at step 1206. If not, the system prompts the client to either authorize payment by a credit card or to transfer sufficient funds into the client's pre-paid account at step 1204. The client can optionally cancel the appointment at step 1205. If the client has authorized payment, the system will initiate the callback to the client at step 1206. Note that, at any time before a session scheduled for a future time commences, the client can log in to the system and reschedule or cancel the previously scheduled appointment.

If the channel selected for the callback is a telephone connection, the system checks that the client's profile includes a telephone number. If not, the client is prompted to enter a telephone number. When the time for connecting the counselor to the client arrives, the system contacts the client, the counselor, and connects the two over a telephone connection. The counselor is marked as busy for the duration of the session.

If the channel selected for the callback is a chat room connection, the system transmits a request for a chat message to a chat system, which connects the counselor to the client at the scheduled time. The counselor is marked as busy for the duration of the session.

If the channel selected for the callback is a voice-over-Internet (“VOIP”) connection, the system transmits a request for a VOIP message to a VOIP system, which connects the counselor to the client at the scheduled time. The counselor is marked as busy for the duration of the session.

If the channel selected for the callback is a video-over-Internet connection, the system transmits a request for a video conference message to a video conference system, which connects the counselor to the client at the scheduled time. The counselor is marked as busy for the duration of the session.

During each of the Internet based channels, the client and counselor can be notified of the time remaining in the session.

Once the session has terminated the client can be prompted to buy more session time. If the client does not have a pre-paid account, this prompt can include a prompt to open such an account. In addition, the client can be presented with one or more survey questions regarding the session. If the session was over a telephone connection, the question can be presented by the IVR system. If the session was an Internet session, the questions can be presented in a succession of one or more web pages.

If for some reason, a counselor is not available for a selected channel and time, the system can prompt a CSR to assist the client. A client can also request a callback from a CSR. A CSR can assist a client in managing his or her profile or payment account, and can assist a client in locating a suitable and available counselor based on a conversation with the client. Each CSR has a login account with the system and can view counselor schedules in the same manner as a client with web access. The CSR can convey this information to the client during a telephone call. Similarly, the CSR assist the client to authorize payment during a telephone call. Once payment is authorized and a session is scheduled, the CSR can send the request for callback to the system. The system will connect the client to the counselor at the scheduled time.

In addition to the preceding description, the reader is also referred to the disclosure of the above referenced provisional patent application (Ser. No. 60/197,961), the contents of which are incorporated herein by reference.

Although the embodiment presented herein is in the context of providing mental health services to clients, it will be immediately apparent that the system of the invention is applicable to any professional service where a professional provides advice to a client, and does not require physical contact with the client. Variations and modifications to the disclosed embodiment are possible without departing from the spirit and scope of the present invention. The invention is defined by the following claims.

What is claimed is:

1. A method for a client to contact a counseling provider over a communications network comprising the steps of:
a client logging in to a counseling service over a communications network;
presenting by the counseling service the client with a list of counselors and the times slots in which they are available;
selecting a counselor from the list of counselors and time slots;
scheduling a time slot for a session with the counselor; and
establishing a communication connection between the client and the selected counselor at the scheduled time slot.

2. The method of claim 1, wherein the communications network is a computer network.

3. The method of claim 2, wherein the list of available counselors is presented to the client on a web site.

4. The method of claim 1, wherein the communications network is a telephone network.

5. The method of claim 4, wherein the list of available counselors is presented to the client over the telephone connection by either an interactive voice response system or a customer service representative.

6. The method of claim 1, wherein the session time slot can be scheduled in the future.

7. The method of claim 6, further comprising the step of the client rescheduling a session scheduled for a future time slot.

8. The method of claim 1, wherein the session time slot can be scheduled immediately for the client.

9. The method of claim 1, wherein the communication connection established between the client and the selected counselor is over a computer network.

10. The method of claim 9, wherein the communication connection is selected from a group consisting of an Internet chat room, a voice-over-Internet connection, and a video-over-Internet connection.

11. The method of claim 1, wherein the communication between the client and the selected counselor is established over a telephone network.

12. The method of claim 1, further comprising the steps of:
presenting by the service the client with a list of payment options; and
the client selecting a payment option from the list of payment options.

13. The method of claim 12, wherein the payment options comprise a pre-paid account and a pay-as-you-go account.

14. The method of claim 12, further comprising the step of, after the session, offering the client to opportunity to buy more session time.

15. The method of claim 1, further comprising the step of, after the counseling session, presenting the client with one or more survey questions to answer.

16. A method for a counselor to contact a client over a communications network comprising the steps of:
a counselor logging into a counseling service over a communications network;
the counselor indicating availability for connection to a client;
the counselor being contacted by the service to be connected to a client; and
establishing a communication connection between the counselor and the client.

17. The method of claim 16, further comprising the step of the counselor providing the service with at least one communication connection mode for connection to a client, and a contact number for that communication connection mode.

18. The method of claim 17, wherein the counselor provides, along with the at least one communication connection mode, a schedule comprising one or more times slots of availability for that communication connection mode.

19. The method of claim 18, wherein the counselor can change the time of a time slot of availability for a communication connection mode, for a time slot of availability previously provided to the counseling service.

20. The method of claim 18, wherein the counselor provides the schedule to the service over a telephone network.

21. The method of claim 18, wherein the schedule is communicated to a client over a telephone connection by an interactive voice response system operated by the service.

22. The method of claim 18, wherein the schedule is communicated to a client over a telephone connection by a customer service representative employed by the service.

23. The method of claim 18, wherein the counselor provides the schedule to the service over a computer network.

24. The method of claim 18, wherein the schedule is posted on a web site operated by the service.

25. The method of claim 17, wherein the communication connection mode is a telephone network, and the contact number for that mode is a phone number.

26. The method of claim 17, wherein the communication connection mode is a computer network, and the contact number for that mode is an address of a computer on that network.

27. The method of claim 26, wherein the communication connection mode is one of a chat room session, a voice-over-Internet connection, or a video-over-Internet connection.

28. The method of claim 17, wherein the communication connection established between the counselor and the client is one of the at least one communication connections modes provided to the service by the counselor.

29. The method of claim 16, wherein the service contacts the counselor over a telephone network for connection to a client.

30. The method of claim 16, wherein the service contacts the counselor over a computer network for connection to a client.

31. The method of claim 16, wherein the communications network over which the counselor logged into the counseling service is a telephone network.

32. The method of claim 31, wherein the counselor indicates availability to an interactive voice response system operated by the service.

33. The method of claim 31, wherein the counselor indicates availability to a customer service representative employed by the service.

34. The method of claim 16, wherein the communications network over which the counselor logged into the counseling service is a computer network.

35. The method of claim 34, wherein the counselor indicates availability to a web site operated by the service.

36. The method of claim 16, further comprising the step of the counselor providing the service with at least one specialization category.

37. A method of connecting a client to a counselor over a communications network comprising the steps of:
a counselor logging into a counseling service over a first communications network;
the counselor indicating availability for connection to a client;
a client logging in to the counseling service over a second communications network;
presenting to the client a list of counselors and the times slots in which they are available;
selecting a counselor from the list of counselors and time slots;
scheduling a time slot for a session with the counselor;
the counselor being contacted by the service to be connected to the client; and
establishing a communication connection between the client and the selected counselor at the scheduled time slot.

38. The method of claim 37, wherein the first communications network is a computer network.

39. The method of claim 38, wherein the counselor indicates availability to a web site operated by the service.

40. The method of claim 37, wherein the second communications network is a computer network.

41. The method of claim 40, wherein the list of available counselors is presented to the client on a web site.

42. The method of claim 37, wherein the first communications network is a telephone network.

43. The method of claim 42, wherein the counselor indicates availability to either an interactive voice response system operated by the service, or to a customer service representative employed by the service.

44. The method of claim 37, wherein the second communications network is a computer network.

45. The method of claim 44, wherein the list of available counselors is presented to the client over the telephone connection by either an interactive voice response system or a customer service representative.

46. The method of claim 37, further comprising the step of the counselor providing the service with at least one specialization category.

47. The method of claim 37, further comprising the steps of:
presenting to the client a list of payment options; and
the client selecting a payment option from the list of payment options.

48. The method of claim 47, wherein the payment options comprise a pre-paid account and a pay-as-you-go account.

49. The method of claim 47, further comprising the step of, after the session, offering the client to opportunity to buy more session time.

50. The method of claim 37, further comprising the step of, after the counseling session, presenting the client with one or more survey questions to answer.

51. The method of claim 37, wherein the session time slot can be scheduled in the future.

52. The method of claim 51, further comprising the step of the client rescheduling a session scheduled for a future time slot.

53. The method of claim 37, wherein the session time slot can be scheduled immediately for the client.

54. The method of claim 37, further comprising the step of the counselor providing the service with at least one communication connection mode for connection to a client, and a contact number for that communication connection mode.

55. The method of claim 54, wherein the counselor provides, along with the at least one communication connection mode, a schedule comprising one or more times slots of availability for that communication connection mode.

56. The method of claim 55, wherein the counselor can change the time of a time slot of availability for a communication connection mode, for a time slot of availability previously provided to the counseling service.

57. The method of claim 55, wherein the counselor provides the schedule to the service over a telephone network.

58. The method of claim 55, wherein the counselor provides the schedule to the service over a computer network.

59. The method of claim 54, wherein the communication connection mode is a telephone network, and the contact number for that mode is a phone number.

60. The method of claim 54, wherein the communication connection mode is a computer network, and the contact number for that mode is an address of a computer on that network.

61. The method of claim 60, wherein the communication connection mode is one of a chat room session, a voice-over-Internet connection, or a video-over-Internet connection.

62. The method of claim 54, wherein the communication connection established between the counselor and the client is one of the at least one communication connections modes provided to the service by the counselor.

63. The method of claim 37, wherein the service contacts the counselor over a telephone network for connection to a client.

64. The method of claim 37, wherein the service contacts the counselor over a computer network for connection to a client.

65. A system of connecting a client to a counselor over a communications network, said system comprising:
means for a counselor to log into a counseling service over a first communications network;
means for the counselor to indicate availability for connection to a client;
means for a client to log into the counseling service over a second communications network;
means for presenting to the client a list of counselors and the times slots in which they are available;
means for the client to select a counselor from the list of counselors and time slots;
means for scheduling a time slot for a session with the counselor;
means for contacting the counselor for connection to the client; and
means for establishing a communication connection between the client and the selected counselor at the scheduled time slot.

66. The system of claim 65, wherein the first communications network is a computer network.

67. The system of claim 66, wherein the means for the counselor to indicate availability is a web site operated by the service.

68. The system of claim 65, wherein the second communications network is a computer network.

69. The system of claim 68, wherein the means for presenting to the client the list of available counselors is a web site.

70. The system of claim 65, wherein the first communications network is a telephone network.

71. The system of claim 70, wherein the means for the counselor to indicate availability is either an interactive voice response system operated by the service, or a customer service representative employed by the service.

72. The system of claim 65, wherein the second communications network is a computer network.

73. The system of claim 72, wherein the means for presenting the list of available counselors over the telephone connection to the client is either an interactive voice response system or a customer service representative.

74. The system of claim 65, further comprising means for 10 the counselor to provide the service with at least one specialization category.

75. The system of claim 65, further comprising:
means for presenting to the client a list of payment options; and
means for the client to select a payment option from the list of payment options.

76. The system of claim 75, wherein the payment options comprise a pre-paid account and a pay-as-you-go account.

77. The system of claim 75, further comprising means for, after the session, offering the client the opportunity to buy more session time.

78. The system of claim 65, further comprising means for, after the counseling session, presenting the client with one or more survey questions to answer.

79. The system of claim 65, wherein the session time slot can be scheduled in the future.

80. The system of claim 79, further comprising means for the client to reschedule a session scheduled for a future time slot.

81. The system of claim 65, wherein the session time slot can be scheduled immediately for the client.

82. The system of claim 65, further comprising means for the counselor to provide the service with at least one communication connection mode for connection to a client, and a contact number for that communication connection mode.

83. The system of claim 82, further comprising means for the counselor to provide, along with the at least one communication connection mode, a schedule comprising one or more times slots of availability for that communication connection mode.

84. The system of claim 83, further comprising means for the counselor to change the time of a time slot of availability for a communication connection mode, for a time slot of availability previously provided to the counseling service.

85. The system of claim 83, wherein the means for providing the schedule to the service comprises a telephone network.

86. The system of claim 83, wherein the means for providing the schedule to the service comprises a computer network.

87. The system of claim 82, wherein the communication connection mode is a telephone network, and the contact number for that mode is a phone number.

88. The system of claim 82, wherein the communication connection mode is a computer network, and the contact number for that mode is an address of a computer on that network.

89. The system of claim 88, wherein the communication connection mode is one of a chat room session, a voice-over-Internet connection, or a video-over-Internet connection.

90. The system of claim 82, wherein the communication connection established between the counselor and the client is one of the at least one communication connections modes provided to the service by the counselor.

91. The system of claim 65, wherein the means for the service to contact the counselor for connection to a client comprises a telephone network.

92. The system of claim 65, wherein the means for the service to contact the counselor for connection to a client comprises a computer network.
